(19) United States
(12) Patent Application Publication
(10) Pub. No.: US 2002/0010602 A1
(43) Pub. Date: Jan. 24, 2002

(54) Method for individually renting private car, system to individually rent private car and storage medium storing control program to control same

(75) Inventor: Satoshi Tamai, Tokyo (JP)

Correspondence Address: SUGHRUE, MION, ZINN,, MACPEAK & SEAS, 2100 Pennsylvania Avenue, N.W., Washington, DC, 20037-3202, US

(73) Assignee: NEC CORPORATION

(21) Appl. No.: 09/900,892

(22) Filed: Jul. 10, 2001

(30) Foreign Application Priority Data
Jul. 14, 2000 (JP) 215247/2000

(51) Int. Cl. G06F 17/60

(52) U.S. Cl. 705/5; 705/1

(57) ABSTRACT

A method for individually renting a private car is provided which enables a traveler to rent the private car of a dealer at a place where a journey is made. First customer information about a scheduled traveling period during which a party from whom a car is rent is transmitted. The first customer information is input to a dealer server via a dealer terminal and private car availability information is provided a party who is scheduled to visit a region where the private car which the first customer owns is present. The party to whom the car is to be rented reads the private car availability information and, if a desired private car exists, rent request information is input to the dealer server and is transferred to the other dealer terminal to inform the party from whom the car is rent, of a desire for renting the private car.

### BACKGROUND OF THE INVENTION

1. Field of the Invention

The present invention relates to a method and a system for individually renting a private car and more particularly to the method and system for individually renting the private car which are suitably applied to a case where a traveler rents the private car of an other which is not used, at a place where a journey is made and to a storage medium storing control program to control the same.

The present application claims priority of Japanese Patent Application No. 2000-215247 filed on Jul. 14, 2001, which is hereby incorporated by reference.

2. Description of the Related Art

Generally, when a traveler rents a car at a place where a journey is made, the traveler rents a rental car from a local business office of a car-rental company.

A conventional car rental system of this type is, as shown in FIG. 4, includes a dealer terminal 1 and a database 2. The dealer terminal 1 is made up of, for example, a personal computer and terms of rent of a car desired by the traveler are input therein by manipulation of the traveler and/or a dealer. The database 2 is made up of, for example, a storage device such as a hard disk and information about a stock state of the rental car is accumulated therein.

In the conventional rental system, when the traveler visits the local business office of the car-rental company, terms of a rental car desired by the traveler are input to the dealer terminal 1 and information stored in the database 2 is retrieved and, if there is a stock of a rental car that can meet the terms desired by the traveler, the rental car is rented to the traveler.

However, the above conventional rental system has the following problems. That is, since the rental car that can be rented is limited to cars possessed by the car-rental company, the stock of the rental car of a model which the traveler is desirous to rent has run short in many cases.

### SUMMARY OF THE INVENTION

In view of the above, it is an object of the present invention to provide a method and a system for individually renting a private car that enables a traveler (a second customer) to easily rent the private car that the traveler desires to rent (from a first customer) at a place where a journey is made and a storage medium storing control program to control the same.

According to a first aspect of the present invention, there is provided a method for individually renting a private car employed in an individual private car renting system made up of a first dealer terminal, dealer server, second dealer terminal, and communication line, the method including :

first customer information transmitting processing causing the first dealer terminal to produce unused period information representing a period during which the private car possessed by a first customer is not used, private car information representing a model of the private car, car housing place information representing a place where the private car is housed during the unused period and to transmit them to the communication line as the first customer information;

private car availability information causing the dealer server to receive the first customer information through the communication line and to produce the private car availability information representing a private car availability state in each region and then to transmit it to the communication line;

rent request information transmitting processing causing the second dealer terminal to receive the private car availability information through the communication line and to provide the private car availability information to a second customer who is scheduled to visit the region where the housing place of the private car exists and allowing the second customer to read the private car availability information and, if there is a private car that is able to be rented, causing the second dealer terminal to produce the rent request information representing a request for renting the private car and to transmit it to the communication line; and

rent request information transferring processing causing the dealer server to receive the rent request information through the communication line and to transfer the rent request information through the communication line to the first dealer terminal and, at a same time, to update the private car availability information based on the rent request information.

According to a second aspect of the present invention, there is provided a method for individually renting a private car employed in an individual private car renting system made up of a first dealer terminal, dealer server, second dealer terminal, and communication line, the method including :

first customer information transmitting processing causing the first dealer terminal to produce scheduled traveling period information representing a scheduled traveling period during which a private car possessed by a first customer is not used, private car information representing a model of the private car and car housing place where the private car is housed during the scheduled traveling period and to transmit them to the communication line as a first customer information;

private car availability transmitting processing causing the dealer server to receive the first customer information through the communication line and to produce private car availability information representing a private car availability state in each region and to transmit it to the communication line;

rent request information transmitting processing causing the second dealer terminal to receive the private car availability information through the communication line and to provide the private car availability information to a second customer who is scheduled to visit a region where the car housing place of the private car exists and allowing the second customer to read the private car availability information and, if there is a private car that is able to be rented, causing the second dealer terminal to produce rent request information representing a request for renting the private car; and

rent request information transferring processing causing the dealer server to receive the rent request information through the communication line and to transfer the rent request information to the first dealer terminal through the communication line and to update the private car availability information based on the rent request information.

In the foregoing, a preferable mode is one wherein the communication line is made up of an intranet, provided in a local area, connecting the first dealer terminal, the dealer server, and the second dealer terminal.

According to a third aspect of the present invention, there is provided a system to individually rent a private car including

a first dealer terminal to produce unused period information representing a period during which the private car possessed by a first customer is not used, private car information representing a model of the private car, car housing place information representing a car housing place where the private car is housed during the unused period and to transmit them to a communication line as a first customer information;

a second dealer terminal to receive private car availability information through the communication line and to provide the private car availability information to a second customer who is scheduled to visit the region where the car housing place of the private car exists and to allow the second customer to read the private car availability information and, if there is a private car that is able to be rented, to cause the second dealer terminal to produce rent request information representing a request for renting the private car and to transmit it to the communication line; and

a dealer server to receive the first customer information through the communication line and to produce the private car availability information representing a private car availability state in each region and to transmit it to the communication line,

and to receive the rent request information through the communication line and to transfer the rent request information through the communication line to the first dealer terminal and update the private car availability information based on the rent request information.

According to a fourth aspect of the present invention, there is provided a system to individually rent a private car including

a first dealer terminal to receive a scheduled traveling period information representing a scheduled traveling period during which the private car possessed by a first customer is not used, private car information representing a model of the private car, car housing place information representing a car housing place where the private car is housed during the scheduled traveling period and to transmit them to a communication line as a first customer information;

a second dealer terminal to receive private car availability information through the communication line and to provide the private car availability information to a second customer who is scheduled to visit the region where the car housing place of the private car exists and to allow the second customer to read the private car availability information and, if there is a private car that is able to be rented, to cause the second dealer terminal to produce rent request information representing a request for renting the private car and to transmit it to the communication line; and

a dealer server to receive the first customer information through the communication line and to produce the private car availability information representing a private car availability state in each region and to transmit it to the communication line,

and to receive the rent request information through the communication line and to transfer the rent request information through the communication line to the first dealer terminal and to update the private car availability information based on the rent request information.

In the foregoing, a preferable mode is one wherein the communication line is made up of an intranet, provided in a local area, connecting the first dealer terminal, the dealer server, and the second dealer terminal.

According to a fifth aspect of the present invention, there is provided a storage medium storing control program to have a computer execute a method for individually renting a private car employed in an individual private car renting system made up of a first dealer terminal, dealer server, second dealer terminal, and communication line, the method including:

first customer information transmitting processing causing the first dealer terminal to produce unused period information representing a period during which the private car possessed by a first customer is not used, private car information representing a model of the private car, car housing place information representing a place where the private car is housed during the unused period and to transmit them to the communication line as the first customer information;

private car availability information causing the dealer server to receive the first customer information through the communication line and to produce the private car availability information representing a private car availability state in each region and then to transmit it to the communication line;

rent request information transmitting processing causing the second dealer terminal to receive the private car availability information through the communication line and to provide the private car availability information to a second customer who is scheduled to visit the region where the housing place of the private car exists and allowing the second customer to read the private car availability information and, if there is a private car that is able to be rented, causing the second dealer terminal to produce the rent request information representing a request for renting the private car and to transmit it to the communication line; and

rent request information transferring processing causing the dealer server to receive the rent request information through the communication line and to transfer the rent request information through the communication line to the first dealer terminal and, at a same time, to update the private car availability information based on the rent request information.

According to a sixth aspect of the present invention, there is provided a storage medium storing control program to have a computer execute a method for individually renting a private car employed in an individual private car renting system made up of a first dealer terminal, dealer server, second dealer terminal, and communication line, the method including:

first customer information transmitting processing causing the first dealer terminal to produce scheduled traveling period information representing a scheduled traveling period during which a private car possessed by a first customer is not used, private car information representing a model of the private car and car housing place where the private car is housed during the scheduled traveling period and to transmit them to the communication line as a first customer information;

private car availability transmitting processing causing the dealer server to receive the first customer information through the communication line and to produce private car availability information representing a private car availability state in each region and to transmit it to the communication line;

rent request information transmitting processing causing the second dealer terminal to receive the private car availability information through the communication line and to provide the private car availability information to a second customer who is scheduled to visit a region where the car housing place of the private car exists and allowing the second customer to read the private car availability information and, if there is a private car that is able to be rented, causing the second dealer terminal to produce rent request information representing a request for renting the private car; and

rent request information transferring processing causing the dealer server to receive the rent request information through the communication line and to transfer the rent request information to the first dealer terminal through the communication line and to update the private car availability information based on the rent request information.

With the above configurations, first customer information including information about a scheduled traveling period of a first customer being a party from whom a private car is rented is input to the dealer server and private car availability information is provided to a second customer being a party to whom a car is rented through a second dealer terminal, thus enabling the second customer being the party to whom the car is rented to rent a car that is desirous to rent at a place where a journey is made. This also enables the first customer being the party from whom the car is rented to effectively utilize the private car that the first customer is not using at present. Moreover, a dealer can obtain information about the private car of the first customer (for example, a model name and/or a model year of the private car which can be used for sales activities of new cars.

### BRIEF DESCRIPTION OF THE DRAWINGS

The above and other objects, advantages and features of the present invention will be more apparent from the following description taken in conjunction with the accompanying drawings in which:

FIG. 1 is a block diagram showing configurations of an individual rental system of a private car to implement a method for individually renting the private car according to an embodiment of the present invention;

FIG. 2 is a diagram explaining the method for individually renting the private car according to the embodiment of the present invention;

FIG. 3 shows examples of private car availability information according to the embodiment of the present invention; and

FIG. 4 is a diagram showing configurations of a conventional rental system of a rental car.

### DETAILED DESCRIPTION OF THE PREFERRED EMBODIMENTS

Best modes of carrying out the present invention will be described in further detail using various embodiments with reference to the accompanying drawings.

Embodiment

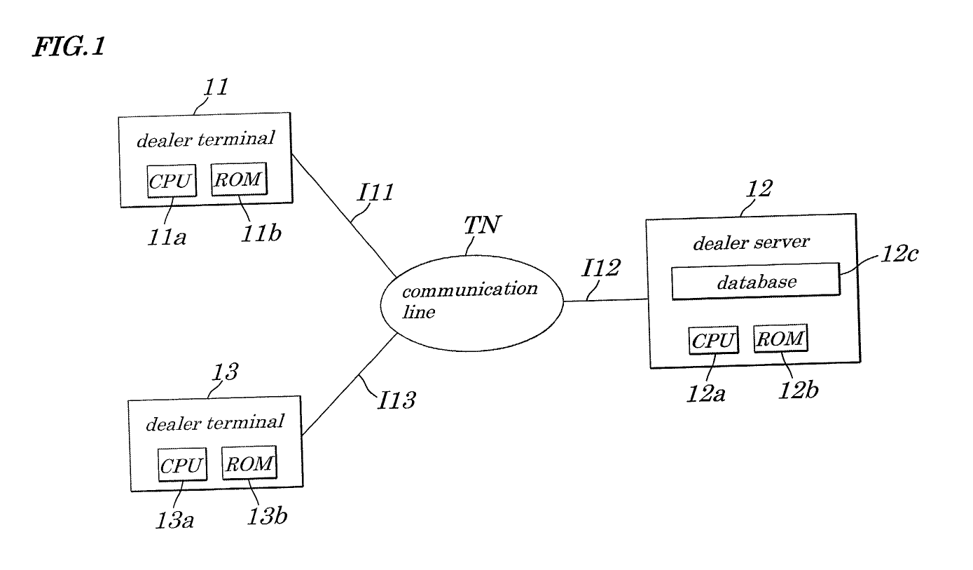

FIG. 1 is a block diagram showing configurations of an individual rental system of a private car to implement a method for individually renting the private car according to an embodiment of the present invention. As shown in FIG. 1, the individual rental system of the private car includes a first dealer terminal 11, a dealer server 12 and a second dealer terminal 13. The first dealer terminal 11 is made up of an information processing device such as a personal computer and has a CPU (Central Processing Unit) 11a adapted to control the entire first dealer terminal 11 and a storage medium 11b such as a ROM (Read Only Memory) storing control programs to operate the CPU 11a. The first dealer terminal 11 is installed at a local business office of a private car rental company or a like which is placed in a region where a first customer (hereinafter referred to as a customer A) lives and produces information about an unused period while a private car possessed by the customer A is not used (for example, a scheduled traveling period during which the customer A does not use the private car due to a long term business trip), a model of the private car and housing place where the private car is housed during the unused period and transmits the information as first customer information I11 to a communication line (for example, an intranet TN).

The dealer server 12 is an information processing device such as the personal computer mounted at a business head office of the private car rental company and has a CPU 12a adapted to control the entire dealer server 12 and a ROM 12b storing control programs to operate the CPU 12a. The dealer server 12 receives the first customer information I11 through the intranet TN and produces private car availability information I12 which represents information about cars being not used at present in each region and then accumulates the information in the database 12c and transmits it to the intranet TN. The database 12c is made up of, for example, a hard disk or a like.

The second dealer terminal 13 is an information processing device such as a personal computer and has a CPU 13a adapted to control the entire second dealer terminal 13 and a ROM 13b storing control programs to operate the CPU 13a.

The second dealer terminal 13 is installed at a local business office of the private car rental company or a like which is placed in a region where a second customer (hereinafter referred to as a customer B) lives and receives the private car availability information I12 through the intranet TN and informs the customer B who is scheduled to visit the region where the housing place of the private car possessed by the customer A exists, of the private car availability information I12 and the customer B reads the private car availability information I12 and, if a private car that can be rent exists, generates rent request information I13 representing a desire for renting the private car and then transmits it to the intranet TN. Moreover, the dealer server 12 receives the rent request information I13 through the intranet TN from the second dealer terminal 13 and transfers the rent request information I13 to the first dealer terminal 11 through the intranet TN and, at the same time, updates the private car availability information I12 based on the rent request information I13.

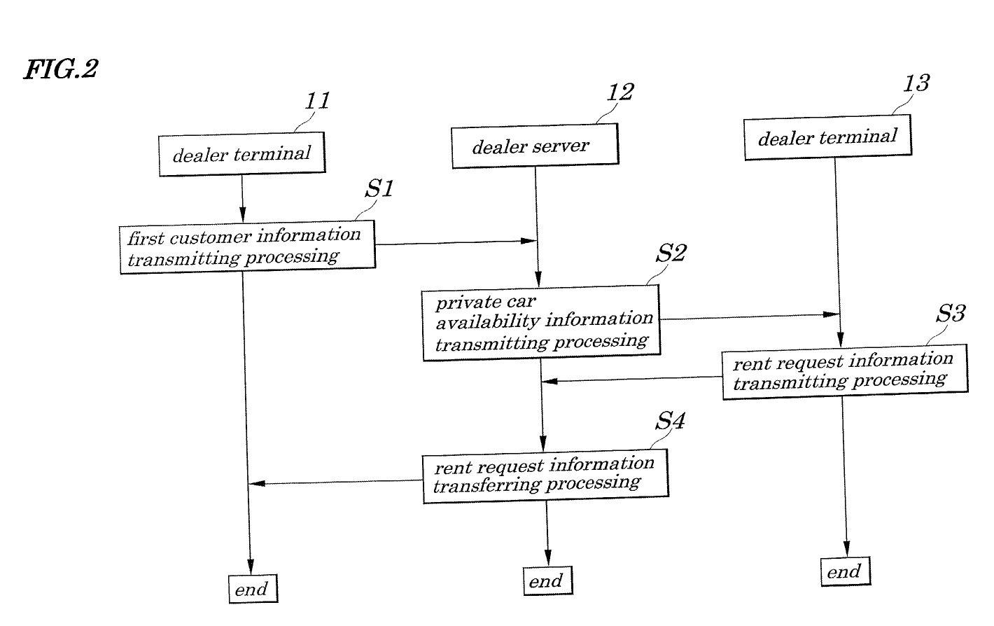

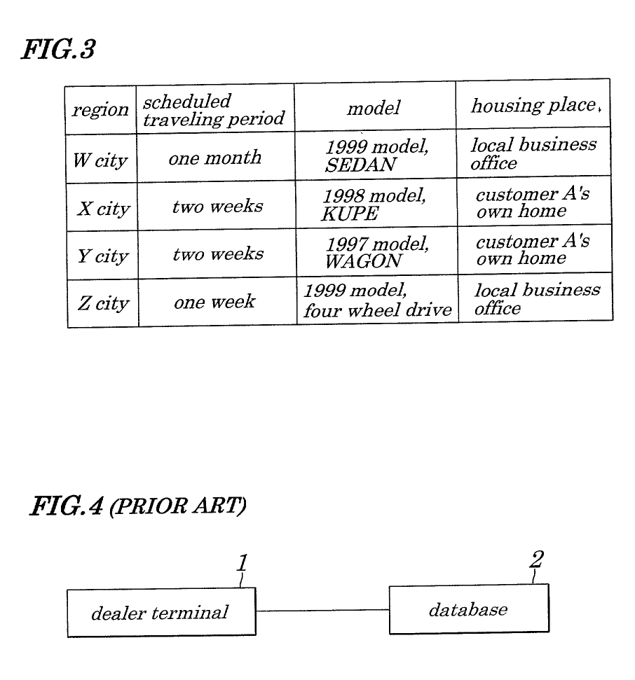

FIG. 2 is a diagram explaining the method for individually renting the private car according to the embodiment of the present invention. FIG. 3 shows examples of the private car availability information I12 according to the embodiment of the present invention. Based on manipulation of the customer A or of a business office operating the first dealer terminal 11, information about the scheduled traveling period (for example, for one month) during which the customer A does not use his/her private car, information about a model name or a model year of the private car (for example, “1999 model”, “SEDAN”, “COUPE”, “WAGON”, and “four wheel drive” or a like) and information about a housing place (for example, a customer home or a local business office of the car dealer) where the private car of the customer A is housed during the scheduled traveling period are produced by the first dealer terminal 11 and are transmitted to the intranet TN as the first customer information I11 (Step S1, first customer information transmitting processing) . The first customer information I11 is input through the intranet TN to the dealer server 12 and is analyzed and, as shown in FIG. 3, the private car availability information I12 representing a state of availability of the private car in each region is produced and is transmitted to the intranet TN (Step S2, private car availability information transmitting processing).

The private car availability information I12 is input through the intranet TN to the second dealer terminal 13 and is provided to the customer B who is scheduled to visit the region where the housing place of the private car of the customer A exists. The customer B reads the private car availability information I12 and, if there is a private car that can be rented, the rent request information I13 representing a desire for renting the private car is produced by the second dealer terminal 13 and is transmitted to the intranet TN (Step S3, rent request information transmitting processing). In this case, for example, a name and an age of the customer B, the number of fellow travelers, desired renting period, estimated mileage, desired rent fee are input to the second dealer terminal 13 and analyzed based on the private car availability information I12 to judge whether there exists a private car that can be rent.

The rent request information I13 is input through the intranet TN to the dealer server 12 and is transferred through the intranet TN to the first dealer terminal 11 and, at the same time, the private car availability information I12 is updated based on the rent request information I13 (Step S4, rent request information transferring processing). In this case, information about the period during which the customer B is scheduled to rent the private car of the customer A and about the model of the private car that the customer B is scheduled to rent is deleted from the private car availability information I12. The rent request information I13 is displayed on the first dealer terminal 11 and the customer A is informed by the business office of a desire for renting the private car of the customer A. Then, if the customer A approves the rental of the private car of the customer A, a rental contract is concluded through the dealer. The customer B, when visiting a region where the housing place of the private car possessed by the customer A exists, rents the private car.

Thus, according to the embodiment of the present invention, since the first customer information I11 including the information about a scheduled traveling period of the customer A is input to the dealer server 12 and the private car availability information I12 is provided to the customer B through the second dealer terminal 13, the customer B can rent a car that the customer B wants to rent at a place where a journey is made. This enables the customer A to effectively utilize the private car that the customer A is not using at present. Moreover, the dealer can obtain information about the private car of the customer A (for example, a model name and/or a model year of the private car which can be used for sales activities of new cars).

It is apparent that the present invention is not limited to the above embodiment but may be changed and modified without departing from the scope and spirit of the invention. For example, the number of the dealer terminals 11 and 13 may be arbitrary. The dealer terminals 11 and 13 are not limited to the personal computer and any purpose-built terminal may be used. In the embodiment, though the customer A is a party from whom the car is rented and the customer B is a party to whom the car is rented, they may be reverse. As the communication line, in addition to the intranet TN, the Internet may be used. However, in this case, since, in some cases, private information of the customer A and B are contained in the first customer information I11, private car availability information I12 and rent request information I13, it is necessary to provide the dealer server 12 with a function of a firewall to encrypt each piece of the information and dealer terminals 11 and 13 with a function of decrypting the encrypted information accordingly.

What is claimed is:

1. A method for individually renting a private car employed in an individual private car renting system made up of a first dealer terminal, dealer server, second dealer terminal, and communication line, said method comprising:
first customer information transmitting processing causing said first dealer terminal to produce unused period information representing a period during which said private car possessed by a first customer is not used, private car information representing a model of said private car, car housing place information representing a place where said private car is housed during said unused period and to transmit them to said communication line as said first customer information;
private car availability information causing said dealer server to receive said first customer information through said communication line and to produce said private car availability information representing a private car availability state in each region and then to transmit it to said communication line;
rent request information transmitting processing causing said second dealer terminal to receive said private car availability information through said communication line and to provide said private car availability information to a second customer who is scheduled to visit said region where said housing place of said private car exists and allowing said second customer to read said private car availability information and, if there is a private car that is able to be rented, causing said second dealer terminal to produce said rent request information representing a request for renting said private car and to transmit it to said communication line; and
rent request information transferring processing causing said dealer server to receive said rent request information through said communication line and to transfer said rent request information through said communication line to said first dealer terminal and, at a same time, to update said private car availability information based on said rent request information.

2. The method for individually renting a private car according to claim 1, wherein said communication line is made up of an intranet, provided in a local area, connecting said first dealer terminal, said dealer server, and said second dealer terminal.

3. A method for individually renting a private car employed in an individual private car renting system made up of a first dealer terminal, dealer server, second dealer terminal, and communication line, said method comprising:
first customer information transmitting processing causing said first dealer terminal to produce scheduled traveling period information representing a scheduled traveling period during which a private car possessed by a first customer is not used, private car information representing a model of said private car and car housing place where said private car is housed during said scheduled traveling period and to transmit them to said communication line as a first customer information;
private car availability transmitting processing causing said dealer server to receive said first customer information through said communication line and to produce private car availability information representing a private car availability state in each region and to transmit it to said communication line;
rent request information transmitting processing causing said second dealer terminal to receive said private car availability information through said communication line and to provide said private car availability information to a second customer who is scheduled to visit a region where said car housing place of said private car exists and allowing said second customer to read said private car availability information and, if there is a private car that is able to be rented, causing said second dealer terminal to produce rent request information representing a request for renting said private car; and
rent request information transferring processing causing said dealer server to receive said rent request information through said communication line and to transfer said rent request information to said first dealer terminal through said communication line and to update said private car availability information based on said rent request information.

4. The method for individually renting a private car according to claim 3, wherein said communication line is made up of an intranet, provided in a local area, connecting said first dealer terminal, said dealer server, and said second dealer terminal.

5. A system to individually rent a private car comprising:
a first dealer terminal to produce unused period information representing a period during which said private car possessed by a first customer is not used, private car information representing a model of said private car, car housing place information representing a car housing place where said private car is housed during said unused period and to transmit them to a communication line as a first customer information;
a second dealer terminal to receive private car availability information through said communication line and to provide said private car availability information to a second customer who is scheduled to visit said region where said car housing place of said private car exists and to allow said second customer to read said private car availability information and, if there is a private car that is able to be rented, to cause said second dealer terminal to produce rent request information representing a request for renting said private car and to transmit it to said communication line; and
a dealer server to receive said first customer's information through said communication line and to said produce private car availability information representing a private car availability state in each region and to transmit it to said communication line,
and to receive said rent request information through said communication line and to transfer said rent request information through said communication line to said first dealer terminal and update said private car availability information based on said rent request information.

6. The system to individually rent a private car according to claim 5, wherein said communication line is made up of an intranet provided in a local area connecting said first dealer terminal, said dealer server, and said second dealer terminal.

7. A system to individually rent a private car comprising:
a first dealer terminal to receive a scheduled traveling period information representing a scheduled traveling period during which said private car possessed by a first customer is not used, private car information representing a model of said private car, car housing place information representing a car housing place where the private car is housed during said scheduled traveling period and to transmit them to a communication line as a first customer information;
a second dealer terminal to receive private car availability information through said communication line and to provide said private car availability information to a second customer who is scheduled to visit said region where said car housing place of said private car exists and to allow said second customer to read said private car availability information and, if there is a private car that is able to be rented, to cause said second dealer terminal to produce rent request information representing a request for renting said private car and to transmit it to said communication line; and
a dealer server to receive said first customer's information through said communication line and to produce said private car availability information representing a private car availability state in each region and to transmit it to said communication line,
and to receive said rent request information through said communication line and to transfer said rent request information through said communication line to said first dealer terminal and to update said private car availability information based on said rent request information.

8. The system to individually rent a private car according to claim 7, wherein said communication line is made up of an intranet provided in a local area connecting said first dealer terminal, said dealer server, and said second dealer terminal.

9. A storage medium storing control program to have a computer execute a method for individually renting a private car employed in an individual private car renting system made up of a first dealer terminal, dealer server, second dealer terminal, and communication line, said method comprising:
first customer information transmitting processing causing said first dealer terminal to produce unused period information representing a period during which said private car possessed by a first customer is not used, private car information representing a model of said private car, car housing place information representing a place where said private car is housed during said unused period and to transmit them to said communication line as said first customer information;
private car availability information causing said dealer server to receive said first customer information through said communication line and to produce said private car availability information representing a private car availability state in each region and then to transmit it to said communication line;
rent request information transmitting processing causing said second dealer terminal to receive said private car availability information through said communication line and to provide said private car availability information to a second customer who is scheduled to visit said region where said housing place of said private car exists and allowing said second customer to read said private car availability information and, if there is a private car that is able to be rented, causing said second dealer terminal to produce said rent request information representing a request for renting said private car and to transmit it to said communication line; and
rent request information transferring processing causing said dealer server to receive said rent request information through said communication line and to transfer said rent request information through said communication line to said first dealer terminal and, at a same time, to update said private car availability information based on said rent request information.

10. A storage medium storing control program to have a computer execute a method for individually renting a private car employed in an individual private car renting system made up of a first dealer terminal, dealer server, second dealer terminal, and communication line, said method comprising:
first customer information transmitting processing causing said first dealer terminal to produce scheduled traveling period information representing a scheduled traveling period during which a private car possessed by a first customer is not used, private car information representing a model of said private car and car housing place where said private car is housed during said scheduled traveling period and to transmit them to said communication line as a first customer information;
private car availability transmitting processing causing said dealer server to receive said first customer information through said communication line and to produce private car availability information representing a private car availability state in each region and to transmit it to said communication line;
rent request information transmitting processing causing said second dealer terminal to receive said private car availability information through said communication line and to provide said private car availability information to a second customer who is scheduled to visit a region where said car housing place of said private car exists and allowing said second customer to read said private car availability information and, if there is a private car that is able to be rented, causing said second dealer terminal to produce rent request information representing a request for renting said private car; and
rent request information transferring processing causing said dealer server to receive said rent request information through said communication line and to transfer said rent request information to said first dealer terminal through said communication line and to update said private car availability information based on said rent request information.
